(19) United States
(12) Patent Application Publication
(10) Pub. No.: US 2006/0150841 A1
(43) Pub. Date: Jul. 13, 2006

(54) Printing press

(75) Inventors: Peter Bachmeier, Leimen (DE); Andreas Detloff, Walldorf (DE); Bernhard Falk, Pfungstadt (DE); Sven Kerpe, Eggenstein-Leopoldshafen (DE); Peter Thoma, Mannheim (DE); Jurgen Ehrhard, Altneudorf (DE); Michael Gieser, Oftersheim (DE); Peter Hachmann, Dossenheim (DE); Sonja Wiegel, Hirschhorn (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/328,414

(22) Filed: Jan. 9, 2006

(30) Foreign Application Priority Data
Jan. 7, 2005 (DE) 10 2005 000 892.5
Jul. 13, 2005 (DE) 10 2005 032 601.3

(51) Int. Cl. B41F 13/24

(52) U.S. Cl. 101/232

(57) ABSTRACT

A printing press contains a sheet guiding device which has an edge. The comb-shaped edge is composed at least partially of a material which is substantially not electrically conductive. This material is advantageous with regard to the configuration of a discharging device disposed in the region of the edge, which discharging device serves to discharge the printing material sheets.

### BACKGROUND OF THE INVENTION

### Field of the Invention

The present invention relates to a printing press having a sheet guiding device which has an edge.

European patent EP 0 922 576 B1 describes a printing press of this type. However, the sheet guiding device of the printing press of the prior art has no favorable preconditions for printing the sheets on both sides.

### SUMMARY OF THE INVENTION

It is accordingly an object of the invention to provide a printing press which overcomes the above-mentioned disadvantages of the prior art devices of this general type, in.which there are favorable preconditions for printing the sheets on both sides.

The printing press according to the invention has a sheet guiding device which has an edge. The invention is distinguished by the fact that the edge is composed at least partially of a material which is substantially not electrically conductive.

The material, which is an electric insulator, makes it possible to dispose a discharging device for discharging the printing material sheets in the region of the edge. The electrostatic charges of the printing material sheet when it enters the region of the sheet guiding device can be reduced by a discharging device of this type to such an extent that, as a consequence, the printing material sheet no longer tends to be attracted electrostatically by the sheet guiding device and to smear on the sheet guiding device with its recto printing side which faces the sheet guiding device during recto and verso printing.

In a further development, the sheet guiding device is composed predominantly of an electrically conductive material. In other developments, the material which is substantially not electrically conductive is polyphenylene sulfide or polyacetal.

In a further development, the edge is comb-shaped and extends longitudinally, transversely relative to a sheet running direction of the printing material sheets.

Other features which are considered as characteristic for the invention are set forth in the appended claims.

Although the invention is illustrated and described herein as embodied in a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of an offset perfecting press having sheetguiding devices according to the invention;

FIG. 2 is a diagrammatic, perspective view of a sheet guiding device shown in FIG. 1;

FIG. 3 is a diagrammatic, side-elevational view of the sheet guiding device shown in FIG. 2;

FIG. 4 is a diagrammatic, side-elevational view of a modification of the sheet guiding device shown in FIG. 3, with a changed fastening, compared with the latter, of a comb-shaped edge element of the sheet guiding device;

FIG. 5 is a diagrammatic, side-elevational view of the sheet guiding device from FIG. 4, together with a UV dryer which is disposed in the immediate vicinity;

FIG. 6 is a diagrammatic, side-elevational view of an exemplary embodiment in which one of the sheet guiding devices from FIG. 1 has a nozzle plate which is provided with a comb-shaped edge; and

FIG. 7 is a diagrammatic, side-elevational view of a detailed illustration of the comb-shaped edge of the sheet guiding device from FIG. 6 and a discharging device which is disposed in the immediate vicinity of the comb-shaped edge.

### DESCRIPTION OF THE PREFERRED EMBODIMENTS

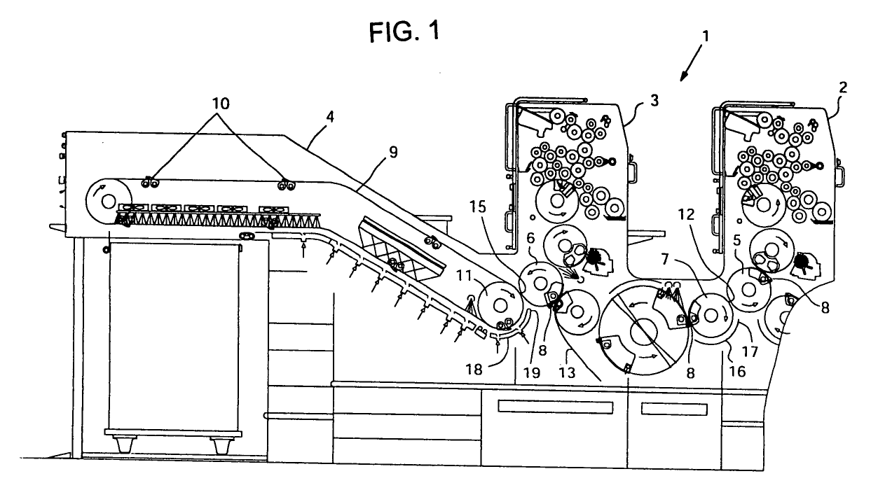

Components and elements which correspond to one another are denoted by the same designations throughout the figures. Referring now to the figures of the drawing in detail and first, particularly, to FIG. 1 thereof, there is shown a sheet-fed printing press 1 having printing units 2, 3 and a deliverer 4. The sheet-fed printing press 1 is a perfecter and contains sheet transport cylinders 5 to 7 which each have at least one gripper system 8. The sheet transport cylinders 5, 6 are impression cylinders of the printing units 2, 3. The sheet transport cylinder 7 is a transfer cylinder. The deliverer 4 contains a chain conveyor 9 having gripper systems 10. The chain conveyor 9 runs around what is known as a delivery drum 11. The sheet transport cylinders 5, 7 together form a transfer region 12, in which the printing material sheet 13 is transferred from the gripper system 8 of the sheet transport cylinder 5 into the gripper system 8 of the sheet transport cylinder 7. Together with the chain conveyor 9, the sheet transport cylinder 6 forms a further transfer region 15, in which the printing material sheet 13 is transferred from the gripper system 8 of the sheet transport cylinder 6 into one of the gripper systems 10 of the chain conveyor 9. A sheet guiding device 16 is disposed below the sheet transport cylinder 7, which sheet guiding device 16 has one end 17 which lies toward the transfer region 12. A sheet guiding device 18 is disposed below the delivery drum 11, which sheet guiding device 18 has one end 19 which lies toward the transfer region 15.

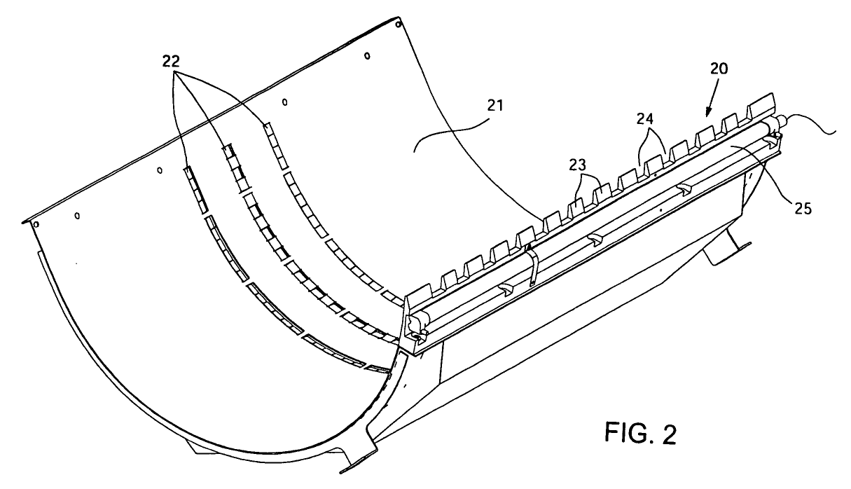

FIG. 2 shows a sheet guiding device which is substantially shell-shaped and has a comb-shaped edge 20. The sheet guiding device can be the sheet guiding device 16 from FIG. 1, the comb-shaped edge 20 being the end 17, and can also be the sheet guiding device 18 from FIG. 1, the comb-shaped edge 20 being the end 19. The sheet guiding device has a concave guide surface 21 with blowing air nozzles 22. The comb-shaped edge 20 has tines 23 and gaps 24 which lie between the latter. The grippers of the gripper system 8 of the sheet transport cylinder 6 or 7 pass through the gaps 24 during the cylinder rotation. A discharging device 25 for eliminating electrostatic charges of the printing material sheets 13 is disposed close to the comb-shaped edge 20. The discharging device 25 is what is known as an active discharging device, the conductor (ionizer) of which serves for “deelectrification” and is connected to a high voltage source which produces a high alternating voltage. The discharging device 25 is what is known as an ion spray rod or ionization rod. The comb-shaped edge 20 and, in particular, its tines 23 are composed at least partially of a material which is substantially not electrically conductive, preferably a plastic such as polyacetal (POM) or polyphenylene sulfide (PPS). The electrical insulation effect of this material ensures a high efficiency of the discharging device 25. The printing material sheets 13 which have been discharged by the discharging device 25 no longer tend to smear fresh printing ink onto the guide surface 21, as the discharged printing material sheets 13 no longer have any static charges which would otherwise cause the printing material sheets 13 to adhere to the guide surface 21.

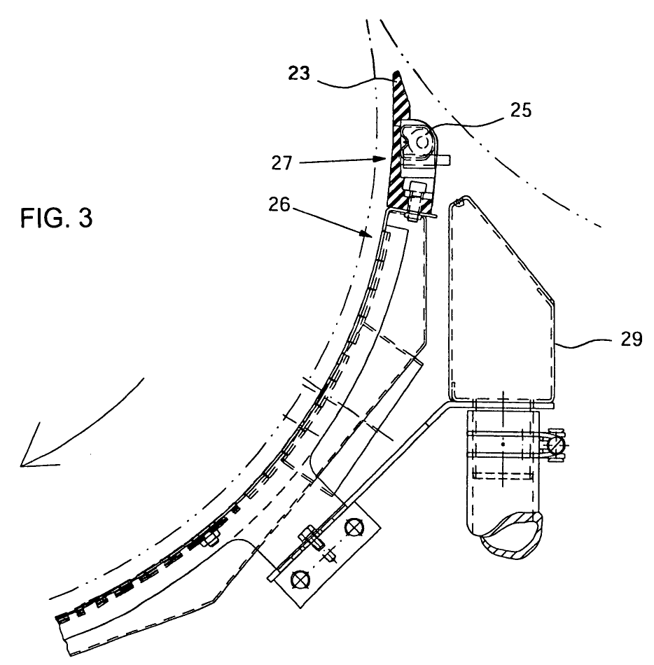

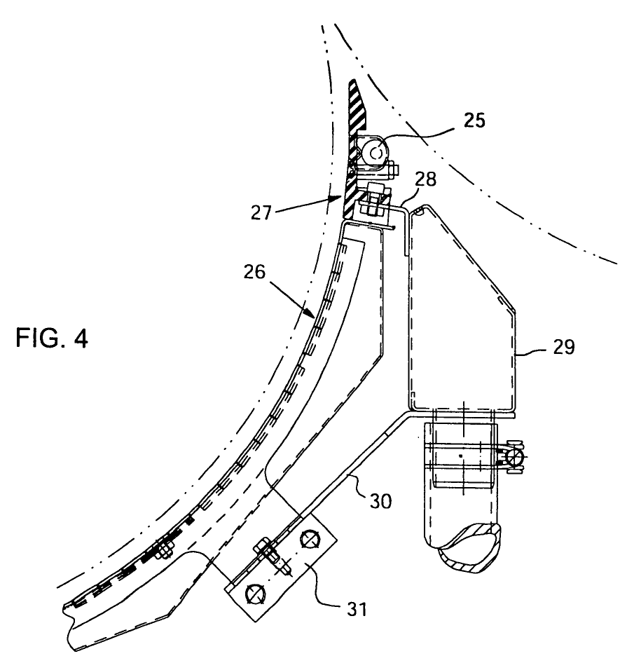

FIGS. 3 and 4 show exemplary embodiments, in which the sheet guiding device from FIG. 2 contains a first part 26 and a second part 27. The first part 26 is a blower box and the second part 27 is the comb-shaped edge 20.

According to FIG. 3, the second part 27 is configured as an attachment element which is connected to the first part 26 via screws.

According to FIG. 4, the second part 27 is configured as a separate element which, although it is in contact with the first part 26, is not connected to the latter. Instead, the second part 27 is fastened here via a holder 28 to a blowing device 29 which is in turn fastened via a further holder 30 to a machine frame 31.

In both the exemplary embodiment shown in FIG. 3 and that shown in FIG. 4, the element which forms the comb-shaped edge 20 is made from the electrically nonconductive material, for example POS or PPS, in a solid configuration. However, the first part 26 is formed of at least for the major part of an electrically conductive material, preferably of a metal. For example, the guiding surface 21 can be manufactured from a steel plate.

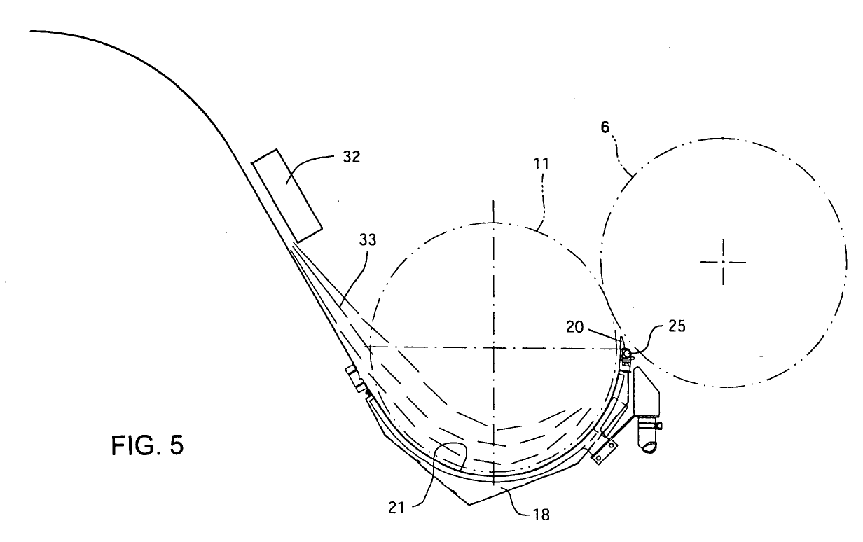

FIG. 5 shows the case in which the sheet guiding device from FIG. 2 is assigned to the delivery drum 11. Here, it is unimportant whether the sheet guiding device 18 is configured as an attachment element according to FIG. 3 or as a separate element according to FIG. 4. A UV dryer 32 radiates UV radiation 33 which is provided for drying the printing ink on the printing material sheet 13, passes partially into the interior of the skeletally configured delivery drum 11 and is deflected and reflected by the guide surface 21 toward the comb-shaped edge 20. Here, the comb-shaped edge 20 is composed of polyphenylene sulfide (PPS) or a material which is resistant to the UV radiation 33 in a comparable manner and insulates electrically at the same time. The resistance to UV radiation of the comb-shaped edge 20 prevents its premature ageing, embrittlement or the like otherwise caused by the UV radiation 33, with the result that the sheet guiding device 18 is not damaged by the UV dryer 32 despite its proximity to the latter.

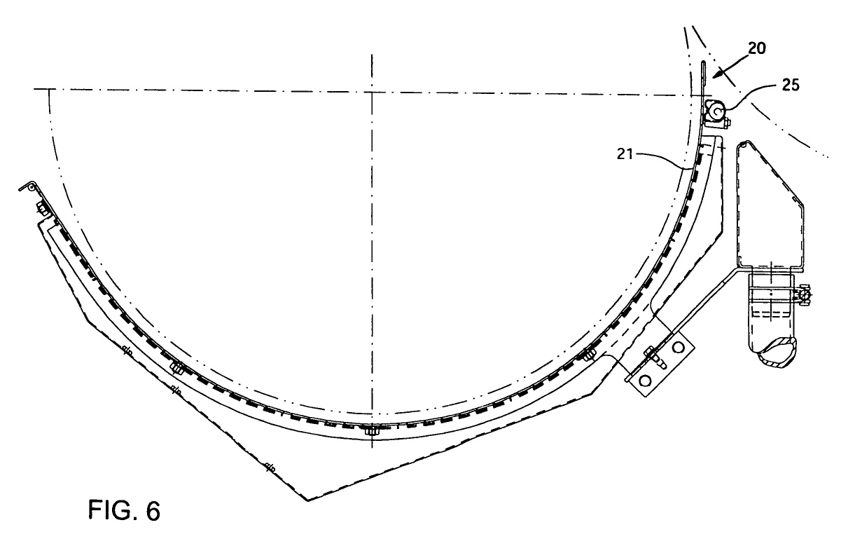

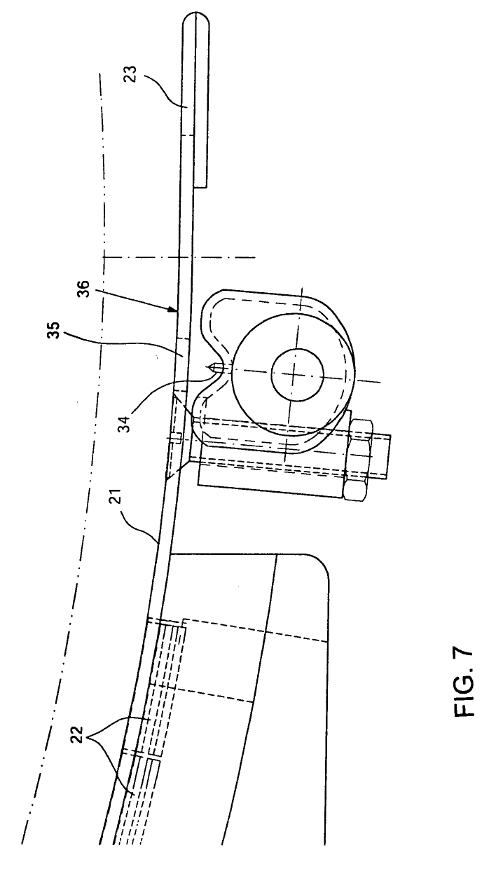

In the exemplary embodiment which is shown in FIGS. 6 and 7, the guide surface 21 and the comb-shaped edge 20 are configured together as a single part. This part is composed of an electrically conductive material and is, for example, a steel plate. In the region of the comb-shaped edge 20, the part is coated with an insulating coating 36, the electrical conductivity of which is considerably lower than the electrical conductivity of the base material, for example of the steel plate. FIG. 7 shows that, in the region of ionizer tips 34 of the discharging device 25, apertures 35 are made in the guide surface 21, the ionizer tips 34 acting on the printing material sheet 13 through said apertures 35.

Modifications to the exemplary embodiments shown in FIGS. 2 to 4 are not shown in the drawing, in which modifications to the attachment or adjoining element which forms the comb-shaped edge 20 is composed of an electrically conductive material, for example steel, and this material is provided with an electrically insulating coating in a similar manner to the exemplary embodiment shown in FIGS. 6 and 7.

This application claims the priority, under 35 U.S.C. § 119, of German patent applications DE 10 2005 000 892.5, filed Jan. 7, 2005 and DE 10 2005 032 601.3, filed Jul. 13, 2005; the entire disclosure of the prior applications are herewith incorporated by reference.

We claim:

1. A printing press, comprising:
a sheet guiding device having an edge, said edge being composed at least partially of a material being substantially not electrically conductive.

2. The printing press according to claim 1, further comprising a discharging device for discharging printing material sheets and disposed in a region of said edge.

3. The printing press according to claim 1, wherein said sheet guiding device is composed predominantly of an electrically conductive material.

4. The printing press according to claim 1, wherein said material which is substantially not electrically conductive is polyphenylene sulfide.

5. The printing press according to claim 1, wherein said material which is substantially not electrically conductive is polyacetal.

6. The printing press according to claim 1, wherein said edge extends longitudinally, transversely relative to a sheet running direction of printing material sheets.

7. The printing press according to claim 1, wherein said edge is a comb-shaped edge.
